(19) United States
(12) Patent Application Publication
(10) Pub. No.: US 2023/0110675 A1
(43) Pub. Date: Apr. 13, 2023

(54) VEHICLE-MANAGED PORTABLE DISTRIBUTED CONNECTIVITY AND MONITORING

(71) Applicant: FORD GLOBAL TECHNOLOGIES, LLC, Dearborn, MI (US)

(72) Inventors: Stuart C. Salter, White Lake, MI (US); Matthew B. RUTMAN, Westland, MI (US); Brendan F. DIAMOND, Grosse Pointe, MI (US); John Robert VAN WIEMEERSCH, Novi, MI (US); Eric Scott LEVINE, Novi, MI (US); William WURZ, San Francisco, CA (US)

(21) Appl. No.: 17/962,835

(22) Filed: Oct. 10, 2022

Related U.S. Application Data
(60) Provisional application No. 63/254,317, filed on Oct. 11, 2021.

(51) Int. Cl. G05D 1/00; G08G 1/0968; H04W 16/18

(52) U.S. Cl. CPC G05D 1/0088; G08G 1/096805; H04W 16/18

(57) ABSTRACT

A vehicle receives designation of a coverage area for deployment of a portable network comprised of a plurality of wireless-equipped toolboxes and determines a plurality of toolboxes available for use in the network based on indications to the vehicle from a plurality of toolboxes that they are usable in the network. The vehicle determines a placement of the available toolboxes within the coverage area to achieve a wireless network having at least one box location capable of reaching a location designated as a vehicle parking location with wireless communication, the location determined by the vehicle based at least in part on the ability of the vehicle to reach the location and a known cellular signal available at the location. The vehicle provides guidance for deployment of individual toolboxes of the plurality of toolboxes at deployment locations according to the determined placement.

### CROSS-REFERENCE TO RELATED APPLICATIONS

This application claims the benefit of U.S. provisional application Serial No. 63/254,317 filed Oct. 11, 2021, the disclosure of which is hereby incorporated in its entirety by reference herein.

### TECHNICAL FIELD

The illustrative embodiments generally related to methods and apparatuses for vehicle-managed portable, distributed connectivity and monitoring.

### BACKGROUND

Active construction sites and remote worksites are often hectic scenes with dozens of workers seeking to complete disparate tasks, while working towards a common goal. Because such sites typically do not have installed power or connectivity for a significant period of time, conventional methods, such as shouting or use of radios, are typically used for on-site communication. While effective for proximate communication, such methods often result in a disconnect between the onsite workers and remote planning resources - such as a central office. Traditionally, information from such a remote location is conveyed to one or more site personnel whose responsibility it becomes to distribute the information to other personnel. This can provide a decrease in communication efficiency, as well as limit direct communication between an instructing party and the intended eventual recipient for the instruction. Cellular phones can solve some of these issues, but cellular signals can be limited based on worker location and signal reception.

Another task often handled by traditional methods is security for the site. Valuable tools and resources are scattered throughout a construction site, and security is often achieved by gated access and a perimeter fence. Such a fence can be expensive to move, and further, it provides limited impediment to malignant activity once a person breaches the perimeter. Certain areas within a site may need to be more secure than others, which requires either building additional fences or posting additional security personnel. Further, such areas may change as the site progresses, requiring fences to be moved in accordance with shifting priorities.

### SUMMARY

In a first illustrative embodiment, a vehicle includes one or more processors configured to receive designation of a coverage area for deployment of a portable network comprised of a plurality of wireless-equipped toolboxes and determine a plurality of toolboxes available for use in the network based on indications to the vehicle from a plurality of toolboxes that they are usable in the network. The one or more processors are also configured to determine a placement of the available toolboxes within the coverage area to achieve a wireless network having at least one box location capable of reaching a location designated as a vehicle parking location with wireless communication, the location determined by the one or more processors based at least in part on the ability of a vehicle to reach the location and a known cellular signal available at the location and provide guidance for deployment of individual toolboxes of the plurality of toolboxes at deployment locations according to the determined placement.

In a second illustrative embodiment, a method includes receiving a placement for a plurality of toolboxes, the placement indicating specific deployment locations for deployment of correlated ones of the plurality of toolboxes and determining that a selected toolbox has been removed from a vehicle for deployment. The method also includes determining a location of the selected toolbox, relative to the specific deployment location correlated to the selective toolbox. Further, the method includes issuing audible or visual guidance for movement from the location of the selected toolbox to the specific deployment location and issuing deployment confirmation guidance when the location of the selected toolbox reaches the specific deployment location.

In a third illustrative embodiment, a method includes receiving designation of a coverage area for deployment of a portable network comprised of a plurality of wireless-equipped toolboxes and determining a plurality of toolboxes available for use in the network based on indications to the vehicle from a plurality of toolboxes that they are usable in the network. The method also includes determining a placement of the available toolboxes within the coverage area to achieve a wireless network having at least one box location capable of reaching a location designated as a vehicle parking location with wireless communication, the location determined by the one or more processors based at least in part on the ability of a vehicle to reach the location and a known cellular signal available at the location. Further, the method includes determining that a selected toolbox has been removed from a vehicle for deployment and determining a location of the selected toolbox, relative to the specific deployment location correlated to the selective toolbox. The method additionally includes issuing audible or visual guidance for movement from the location of the selected toolbox to the specific deployment location and issuing deployment confirmation guidance when the location of the selected toolbox reaches the specific deployment location.

### BRIEF DESCRIPTION OF THE DRAWINGS

FIG. 1 shows an illustrative vehicle and deployable network system;

FIG. 2 shows an illustrative process for site evaluation and portable network deployment;

FIG. 3 shows an illustrative alternative process for portable network deployment;

FIG. 4 shows an illustrative process for network verification and deployment correction;

FIGS. 5A and 5B show illustrative network deployments;

FIG. 6 shows an illustrative process for network modification responsive to detected issues; and

FIG. 7 shows an illustrative monitoring and reaction process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, BLUETOOTH, Wi-Fi, Ultra-Wideband (UWB), cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments contemplate portable, deployable, self-powered networking solutions that can provide mobile access points throughout a site and work cohesively to provide both network coverage and/or security monitoring.

In one example, the solutions include battery-enabled toolboxes with sensing, charging and communication capability. Such a toolbox can perform at least triple duty when fully actuated, providing lockable tool storage, sensor-based site monitoring, and communications access. Since many tasks at a site require tool storage to begin with - redeployable lockable solutions are desirable. At the same time, such solutions can be provided with rechargeable battery power for powering onboard sensors and communication capabilities, placing many of the needs of the jobsite in a single, movable box.

Sensors provided to the toolboxes can work in communication with a central vehicle that has advanced processing power or access to the cloud, where even greater processing power can be realized. This allows for gathering of sensor data at a remote site (e.g., where a box is located) and analysis of the sensor data without necessarily requiring significant onboard processing power to be housed in the toolboxes. Further, communication between boxes and with the central vehicle(s) can provide an adaptable, movable onsite communication network capable of providing intra-site communication and off-site communication through use of a longer-range vehicle communication system.

Communication ranges and signal reception challenges may change on-site as construction progresses, but with a mobile re-deployable solution, changes to communication profiles can be accommodated by simply moving a toolbox. If a toolbox with sensing should remain where it is located to provide security services, a second toolbox can be strategically deployed to circumvent interference and maintain communication. A vehicle computer with an ability to sense lost signals and provided with site mapping, as well as secure zones, can determine optimal deployment solutions that maximize security coverage while maintaining desired communication coverage.

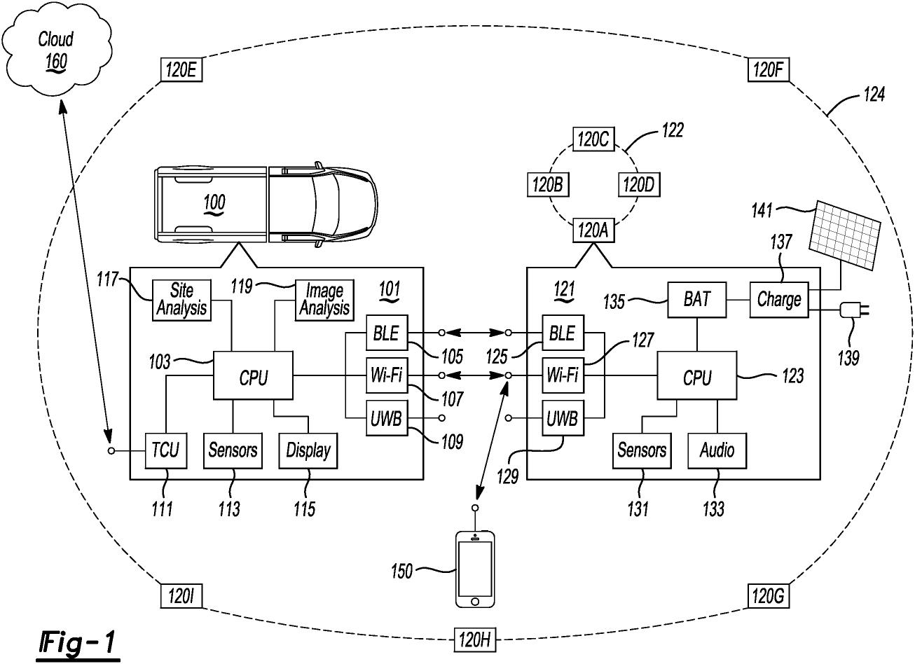

FIG. 1 shows an illustrative vehicle and deployable network system. In this example, a central vehicle 100 serves as the remote communication point for cloud 160 and off-site communication, as well as a network hub and data processing center.

The vehicle may include connection points for engaging a plurality of smart boxes, allowing for charging the boxes (using vehicle charging solutions), configuring box computing and sensing systems, and determining inventory of onboard boxes based at least on connection. Individual inventories of toolboxes can also be tracked based on digital identifiers provided to the tools therein and detected by box sensors. This can aid the vehicle in choosing which box to deploy at which location - e.g., if all boxes have equivalent sensing, charging and communication capability, the vehicle can intelligently choose a given box for deployment based on inclusion of certain tools needed proximate to the deployment location, as indicated by a work plan.

A vehicle computing system 101 may include one or more processors 103 and a variety of short and long range communication capability. For example, the vehicle 100 may include BLUETOOTH or BLUETOOTH low energy transceivers 105, a Wi-Fi transceiver 107 and an ultra or very high frequency transceiver 109 (UHF/VHF). These communication solutions can provide on-site communication, even over significant ranges across a site. A mesh network of boxes can be formed throughout the site, with redundancy when possible or desired, and with the vehicle 100 forming the primary hub.

The vehicle 100 may also include cellular communication with the cloud 160 in the form of a telematics control unit (TCU) 111. This effectively allows all boxes in the network to send communication to and receive communication from the cloud, through the vehicle.

In this example, the vehicle 100 may also include onboard sensing 113, including cameras, ultrasonics, LIDAR, RADAR, etc., which allows the vehicle to function as a monitoring point, as well as allows the vehicle to determine the presence of physical impediments to deployment and determine suitability of a location for deployment - e.g., to so as not to instruct placement of a box in a precarious or impeded locale. Since the vehicle may be capable of determining and adjusting a deployment strategy, even a last-minute decision to change a box deployment based on sensed terrain data may be accommodated by the vehicle determining suitable shifts to other box locations based on a new intended location for the box that is moved due to sensed terrain or site data.

A vehicle display may be used to show a map of the site, as well as intended box deployment locations, and to provide instructions to an operator as to where to drive to deploy boxes. This display can also provide a power map and communications map of deployed boxes. All such displays may also be replicated or reproduced on a mobile device 150 in communication with the vehicle computer.

If a deployment strategy involves leaving the vehicle in a fixed location and carrying one or more boxes to an area the vehicle cannot reach, the box’s communication capabilities may be enabled pre-deployment, allowing the mobile device 150 to continue communication with the vehicle, through the box network, even if the mobile device itself can no longer communicate with the vehicle directly. It may also be reasonable to enable such communication as each box is removed for deployment, so that the vehicle can actively monitor signal strength and ensure that placement instructions provide adequate coverage to maintain the complete network.

In this example, boxes 120A, 120B, 120C, 120D form a first area of coverage 122 and boxes 120E, 120F, 120G, 120H and 1201 form a second area of coverage 124. While all boxes may (or may not) include the same communication and sensing capabilities, use of such capabilities may tax the battery charge of a box, and so in certain deployments, some sensors and/or communication may be enabled or disabled.

For example, if Wi-Fi is used to form the mesh network at the site, all boxes may have their Wi-Fi enabled. If messaging via BLUETOOTH is desired to deliver a message to an onsite device 150, a given box expected to be proximate to the device may have its BLUETOOTH transceiver turned on in conjunction with receiving a message for BLUETOOTH transmission. If sufficient power is present, or sustainable power is present (e.g., solar or a direct power connection), the box can be maximally enabled to a point where power draw is projected not to exceed available power over a desired deployment period. If immediate messaging is required for one or more locations covered by a box, that box can remain sufficiently enabled to provide continual messaging - e.g., skipping the time required for searching and pairing with a local device 150 following BLUETOOTH enablement.

In this example, zone 122 is a higher security zone, such as a zone where valuable equipment or resources are stored longer-term, and the sensor capabilities of boxes forming this zone are enabled to detect entry and exit from the area covered by those sensors. If the sensors are directional in nature, the boxes can be deployed under instructions from a vehicle to correctly provide sensor coverage. An onboard compass or other sensors can be used in conjunction with deployment to determine correct orientation of the box relative to sensing directionality. In another example, the box may have an arrow or indicator that can be aligned with a site object, as instructed by the vehicle. This can include, for example, a verbal instruction to align the box with an object or a visual instruction, provided on a vehicle display or mobile device 150, of how to align the box and/or towards what direction the arrows should be facing.

Boxes may include, but not necessarily or exclusively, onboard systems 121 comprising one or more transceivers. These can include BLUETOOTH low energy transceivers 125, Wi-Fi transceivers 127, UWB or U/VHF transceivers 129, etc. These communication mediums can provide connection to other boxes and/or to the central vehicle 100 itself. Since it may not be practical, nor may it provide optimal coverage, to place all boxes in direct communication range of the vehicle 100, the boxes can be formed into a mesh network with one or more boxes providing the direct pipe to the vehicle, accessible from other boxes by hops.

The boxes may also include sensors 131, such as LIDAR, RADAR, cameras, etc. Data from these sensors can be gathered under instruction of one or more processors 123 and sent to the main vehicle 100 for analysis. Processing power in the box may be limited compared to the main vehicle, to preserve batter life for sensing and communication functions, but could be increased if independent processing were desired. For example, some solutions may include an one or more “master box” that has processing and communication more equivalent to that of a vehicle. All boxes need not have the same capabilities either, but when they have equivalent capabilities they are rendered the most interchangeable.

The box may further include audio output and input 133, which can include speakers and a microphone. A vehicle may be able to use a mechanical arm to deploy boxes, but in the absence of such a feature, a person may be required to deploy the boxes. Deployment instructions may be output through the audio of the box, which can include plain language instructions or increasing decreasing signaling (such as “hot/cold”) wherein the signals get louder and/or more frequent the closer the user moves towards the precisely desired location.

The vehicle can use sensor measurements to determine the relative location of the box, or the box or a user phone may include GPS or other coordinate measurements usable to determine where the box is located at a given moment. Communication with a user phone, for example, which may have a reasonably accurate GPS reading, can allow a phone to be used as a proxy for box location, or the phone could even be placed in a centralized receptacle on the box for the purpose of deployment.

The box may also include a rechargeable power source 135, capable of powering sensors, communication, locks, and even attached tools. Power flow may be controlled by a processor, so that, for example, a tool cannot be run on a box battery when the battery power is needed for other endeavors, unless a user overrides the processor. The battery may have the capability of being charged 137 directly from a power source 139, such as connection to a truck bed or power outlet, or may be charged via solar 141 or other renewable power.

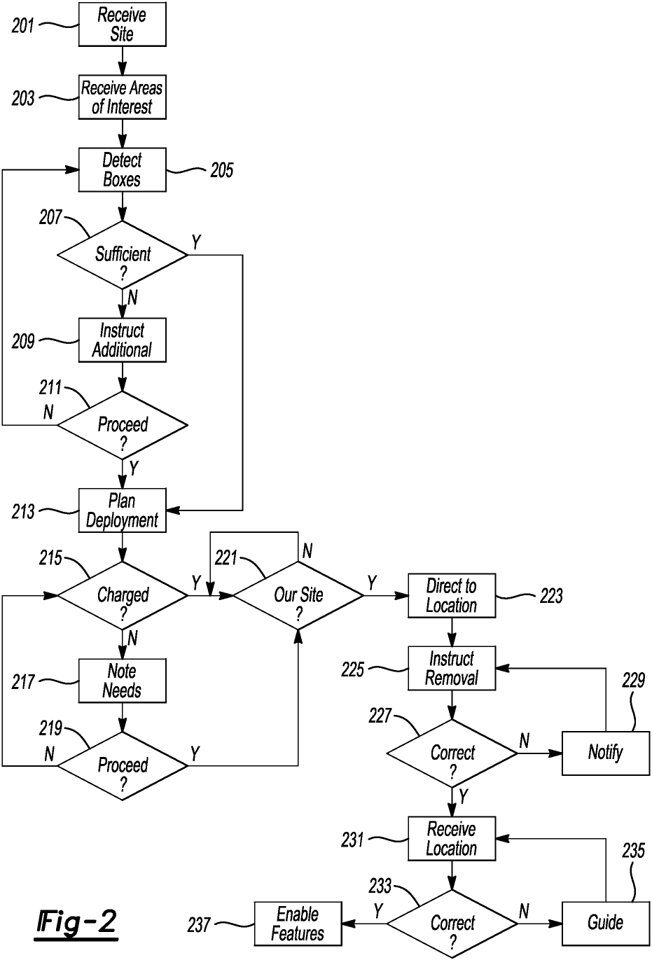

FIG. 2 shows an illustrative process for site evaluation and portable network deployment. In this example, the processes receives identification of a site for box deployment at 201. This can include a full or partial site map, a geofence, etc. The more detail the process has about the topography and impediments on the site, the better the process can plan deployment, but as will be shown, deployment can also be dynamically adjusted onsite.

The process may also receive identification of one or more areas of interest at 203. This can include, for example, identification of workers or types of work that will be performed in certain areas, which can be matched to boxes containing the specific necessary tools as the choice of boxes for deployment in those areas (assuming those boxes have required communication and sensing capabilities to match the deployment strategy).

Areas of interest can also include security designations, including types of monitoring, levels of access, etc. This can be used to determine how tight and aggressive of a perimeter should be established around a region by box deployment. Similarly, areas of possible danger can also be designated for monitoring. Monitoring can include both tracking ingoing and outgoing entities and ensuring (based on AI analysis) whether proper gear is being employed, among other things.

Next the process can sense a number of boxes affixed to or in communication with and available to a given vehicle performing the analysis (if the vehicle performs the analysis) at 205. This may include determining if a minimum number of boxes are present at 207. Knowing the minimum may require first planning a deployment at 213, so these steps are not necessarily required to be sequential and/or non-iterative.

If the process determines a threshold insufficiency at 207, such as not enough boxes to meet a defined minimum or a planned deployment, the process may request additional boxes at 209. Of course, it may be the case that a vehicle is on-site and it only has access to the boxes present, so the user can instruct override of this at 211 and simply proceed with the boxes that are available. The vehicle 100 can then do its best to accommodate a suboptimal solution, which may include gaps in a network or perimeter and which may focus resource deployment based on defined definable priorities - e.g., without limitation, full security coverage before full network coverage.

A final deployment can then be planned at 213, and the process can query the boxes to determine a state of charge at 215. If boxes are insufficiently charged based on planned power usage at 215, the process can notify a user at 217. Again, since the user may be under time or location pressure, the user can override the low power states at 219 and the system can either correct the deployment based on prioritization or use the power that is available to run the network as long as possible.

For example, a system may determine that four boxes will serve a security perimeter and require N power usage per hour to run sensors and networks. If one box is also serving as a pipe for the other three, based on proximity to the vehicle, it may require N+M power per hour. Five additional boxes may simply require P power per hour, less than N, as they will primarily serve as communication points and their sensors will not typically be enabled.

This is an oversimplification, but the point is that the system can project power needs and determine if boxes, such as one box having 8(N+M) power, three boxes having 8M power and five boxes have 8P power are currently present for use in an 8-hour deployment. If no boxes have 8(N+M) for example, the box with the most power could be selected as the pipe point box, and boxes could be rotated as needed - for example, if two boxes had 8(N+.5M) power, those boxes could be switched around the 4-hour mark.

If only four boxes had P power and one box had 0.4P power, and no charging was available, the 0.4P power box could be deployed to a location of least priority.

This also assumes that the correct tools are in the correct boxes, but if needed, tools can be moved or power supplies may be hot-swappable. In other instances, the boxes may have an integrated and hot swappable power supply component, allowing for movement of the swappable component to place the correct amounts of power in the correct boxes (based on tool types) for deployment based on where the tools, network and monitoring demands require. Hot swappable batteries may also be easier to recharge, by simply carrying the batteries to a truck bed as opposed to having to transport the whole toolbox. The toolbox may include a native power supply that charges as a backup whenever the toolbox is affixed, and which can also be used when a hot swap battery expires to either power the toolbox and component or to partially or fully recharge the swappable battery. In other instances, the hot swappable battery may be preserved if the plan deployment calls for a battery swap, and the boxes may run off the native power supplies until those are exhausted, only then using reserve power in the swappable batteries.

Planning swap strategies and power usage can be included in a deployment strategy, based on present power levels, if boxes and/or swappable batteries cannot be charged sufficiently prior to deployment. Swappable batteries would also allow for battery delivery and exchange midday, so a partially realized deployment could be “recharged” by a battery exchange delivered by a vehicle, an autonomous vehicle, a drone, etc.

Once the vehicle is onsite at 221, the process can direct the vehicle to one or more locations for box deployment at 223. In this example, the vehicle is driven (when possible) to close proximity to a deployment site and an instructed box is unloaded. If all boxes have sufficient charge and capability for a task, then the designation of particular boxes may rest solely based on the tools inside. Otherwise, a given box with the correct sensors, tools, power levels, etc. may be selected and instructed for deployment at 225. This instruction can include instructions to move tools to or from another box, move swappable power sources to or from the selected box, etc. If the deployment personnel (when a robot arm is not available, for example) selects the correct box at 227, the process can proceed, otherwise the vehicle (or box or phone) may notify the user of the incorrect box selection at 229, to prevent deploying the wrong box. This notice can be responsive to, for example, box disconnection or removal from the truck, to prevent excessive work with the wrong box.

While the user maneuvers the box into position, the process may receive coordinates of the user or box at 231, and until the box is in the correct location at 233 (and has the correct orientation, if needed), the process can guide the user at 235 through instructions, beeps or sounds, etc. Different sounds or lights may be used to guide placement and orientation so as not to confuse a user. Additionally, orientation may not be engaged until location placement is confirmed. Once the box is correctly placed and/or oriented at 233, the process may enable any disabled features of the box at 237. This can include powering sensors, powering communication needed, etc. The box may operate with minimal capabilities needed for deployment, until deployed, to maximally preserve power. The vehicle may also wait until all boxes are deployed before enabling the additional features, if desired, to preserve power drawn by any features not needed during deployment. Sensors may be temporarily enabled upon deployment to check orientation of a box, based on received sensor signals, and then disabled again if the box needs to be moved.

Once a box has been deployed, the vehicle can move to a next location (driven or autonomously) and/or guide a driver to a next location. When all boxes have been deployed and correctly enabled, the vehicle may drive to a central location (discussed in FIG. 4) and ensure communication with all boxes or determine if boxes need to be repositioned. Certain sensing features may also be enabled at this time, if left quiescent while deployment was completed.

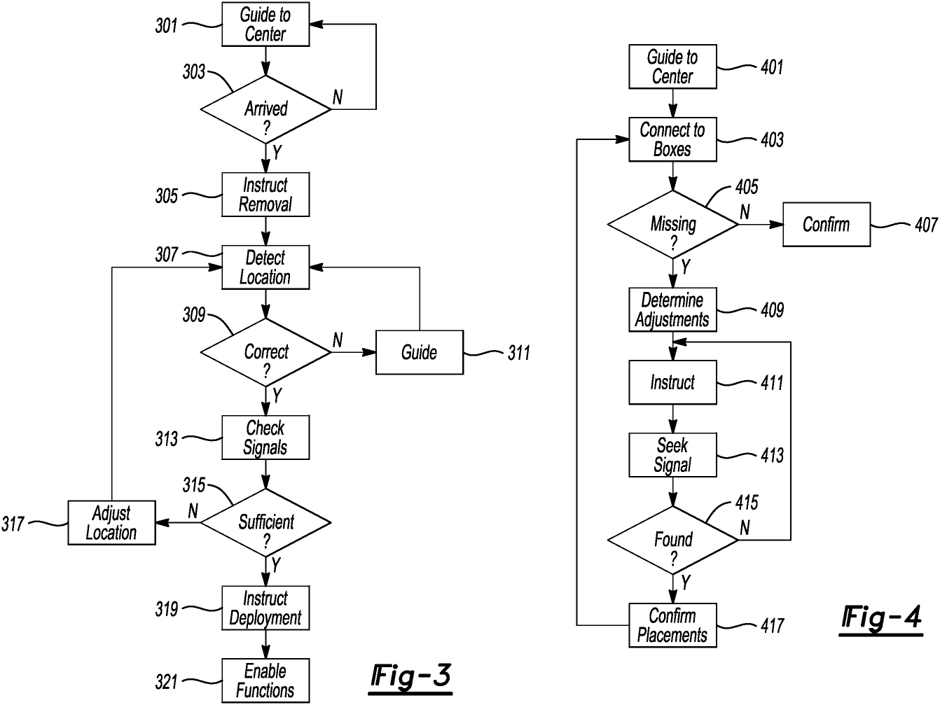

FIG. 3 shows an illustrative alternative process for portable network deployment. In this example, the vehicle instructs deployment from a central location. If the boxes are light enough to be carried a distance, this is an alternative to driving the vehicle to each deployment location. Also, in some instances, ongoing construction, terrain variance, or narrow passages may prevent the vehicle from being able to drive to a deployment location, and so the vehicle may instruct deployment from a more remote location. Even if that remote location is not the central location, the instruction and positioning techniques, and the like, discussed with regards to the illustrative embodiments are still effective.

The vehicle can issue guidance and/or self-drive to the central location, that is, the location where the vehicle intends to reside as a hub, which is likely a location with cellular signals and range to at least one or more of the boxes forming the mesh network. Once the vehicle is at the center at 303, it instructs the removal of a box designated for deployment. If the boxes include GPS and sufficient onboard processing, they can self-direct, as discussed below, to the designated location. In that model, each box can be loaded with coordinates and/or orientation and use onboard sensors and/or a signal from a mobile device, carried by a person carrying the box, or temporarily placed on the box, to guide the user to the location. In other examples, the vehicle may use box or device signals to determine the location of the box and output guidance to the box audio output or a mobile device output, for example.

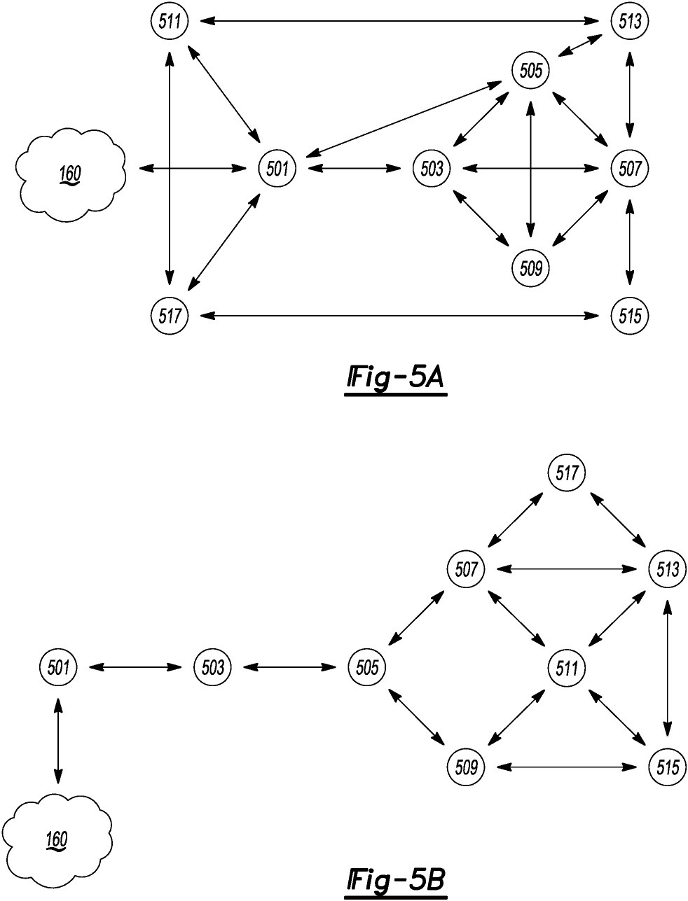

When the vehicle is driving to deployment locations, it instructs removal of the box to be deployed at a given location. In this instance, while instruction may be provided at 305, the user can also simply disconnect a box and the vehicle can determine which box was removed from the vehicle based on disconnection from the vehicle, movement detection for a given box, etc. That is, if a plurality of boxes are to be deployed around a central location, the user may be able to grab the boxes in a somewhat random order. If the network required a series of hops to a remote location, such as in FIG. 5B, then the vehicle 100 may instruct selection of specific boxes chosen to act as the pipe from the remote mesh, to ensure continual connection as the boxes are carried to the more remote points out of range of the vehicle. For example, if work on a building basement was ongoing, a series of several boxes leading underground may be placed to provide a connection for a mesh of boxes deployed in the basement (whose signals cannot reach the vehicle directly). In that instance, the boxes may be deployed in a specific order, so that the connection was present in the basement by the time deployment in the basement began. This is helpful if the vehicle is assisting in box placement, so that the guidance output to the box can be delivered from the vehicle.

Whether using the user’s device, a box GPS or equivalent system, time of flight (ToF) triangulation from multiple vehicle UWB transceivers, or other techniques, the vehicle 100 or the box (if the box is self-managing deployment) detects the current location of the box at 307 and, if not correct (under the deployment strategy) at 309, guides the user to make a change at 311. Guidance can include issuance of verbal instructions or use of tones or light emission that can increase in frequency of occurrence, for example, as the box is closer to the desired location. Similar concepts can be used for orientation of a box, and the orientation may be guided using different tone pitch or different colors so a user can distinguish between orientation instructions and directional instructions.

If the vehicle is at a central planned stopping point, where it will serve as a hub, the vehicle 100 can check the signals received from the box at 313 when the box is in position. This can include the connection to be used for the network, as well as receipt of data to ensure sufficient speed of transmission. Also, if the box is forming a hop-point for one or more additional signals, and the additional boxes have been deployed, the vehicle can ensure that the signal from the additional boxes is received through the current box. If there is a noted deficiency that could lead to an unstable connection at 315, the vehicle can determine a new location at 317 that should increase signal strength. This may also require the movement of other boxes that are designated to connect through the current box, and/or that are providing sensor coverage if the redeployment changes sensor coverage of an area designated for security.

If the location is correct and the signals are sufficient, the process may notify the user of the correct deployment at 319 and enable (if the time is ripe) additional functions of the box at 321 that had been disabled for power preservation. That enablement may also be delayed until all boxes or certain other boxes have been deployed.

FIG. 4 shows an illustrative process for network verification and deployment correction. In this example, the vehicle is checking a network for connections after having traveled around for deployment. The vehicle is guided to a central or designated location at 401 and then attempts to connect to any boxes that are supposed to be in wireless range based on the deployment strategy, at 403.

If no boxes are missing at 405, the vehicle 100 may confirm that the network is effective, and deployment is correct at 407. The check at 405 may also include checking boxes one or more hops away from the vehicle - that is, it can include a confirmation that all boxes in the network are reachable through at least one hop and/or through all designated hops.

If any boxes are missing, the process may determine one or more adjustments to be made to box locations at 409. The process should know where the boxes were placed, so a “missing” box is not likely needed to be sought before being able to plan adjustments, assuming the box has not been moved. In this example, the box may be out of network range, so the vehicle may not necessarily be able to connect to the box to provide guidance through the box, instead, the vehicle may provide guidance through a user device, which can include uploading a guidance command set to the user device in case connection with the user device is lost as well. Presumably, if the guidance is correct, at some point during the repositioning of the box, the box will reconnect to the mesh network and the vehicle can resume guidance through the box.

This may also be an example of a situation where a vehicle uses a U/VHF transceiver to temporarily connect to the box, since that transceiver may have a much greater range than BLE, UWB, or Wi-Fi. Even if that solution is not optimal for long term network connection, the ability to connect at greater distances may allow for vehicle-controlled box-issued guidance for repositioning of a box that is otherwise outside of wireless range. However, instructions are to be or can be issued at 411, the vehicle and/or other devices guide repositioning of the box. The vehicle 100 also continues to seek the wireless signal indicative of the network connection at 413, so that once the signal is found and/or sufficiently strong at 415, the vehicle can confirm that the box has been correctly re-placed at 417.

FIGS. 5A and 5B show illustrative network deployments. In FIG. 5A, the vehicle 501 connects to a plurality of boxes, 503, 505, 511 and 517. Boxes 503, 505, 507 and 509 form a security perimeter around a certain designated location, and boxes 511, 513, 515 and 517 form a wider network perimeter. The direct connections shown between boxes are non-exhaustive in terms of what connections may be possible in this configuration and are presented to demonstrate redundancies.

It may be useful to plan a mesh network with at least two paths for every connection, when possible and boxes and positionings permit. That allows for movement of a box, whether intentional or accidental, and the movement should not fully disrupt the network. Further, since the vehicle should still hopefully be in connection with the moved box through at least one path, the vehicle can issue a notice to the box (audio or visual output) that the box is out of position. This may be overridden so as not to annoy workers when a box is intentionally moved, but also aids in indicating when a box needs to be moved back for network integrity. The boxes also all have a continued connection to the cloud 160, so that off-site instructions, changes, alerts, etc. can be sent to a given box for near immediate delivery to the workers proximate to that box.

The box can also act as a proxy for cellular signals when workers are in a signal-impeded location, by allowing workers to connect their own devices to the box network, they can continue to receive texts and/or phone calls over Wi-Fi, for example, aided by the vehicle connection to the cloud. This allows workers to continue to use personal device when desired and allows for direct messaging to a particular device, even if the device is out of cellular coverage range.

FIG. 5B shows a configuration where a series of boxes may need to be placed in a row to carry a signal from a location (e.g., underground or far within a somewhat completed building, where a vehicle cannot travel) out to the vehicle 501 connection to the cloud 160. In this example, the chain to the vehicle lacks redundancy, only including boxes 503 and 505, but if sufficient boxes were present and suitably deployable, the chain could include redundancies as well.

As noted before, deployment of this configuration may be instructed starting with boxes 503 then 505, so that the vehicle signal can be maintained as deployment continues. Then 507 and then 511 could be deployed, and at that point every box should have at least one connection path based on planned locations and can be deployed in any order.

The network formed by 507, 509, 511, 513 and 515 includes redundancies, so as long as the chain 503, 505 is unbroken, the boxes should be able to send their signals back to the vehicle 501.

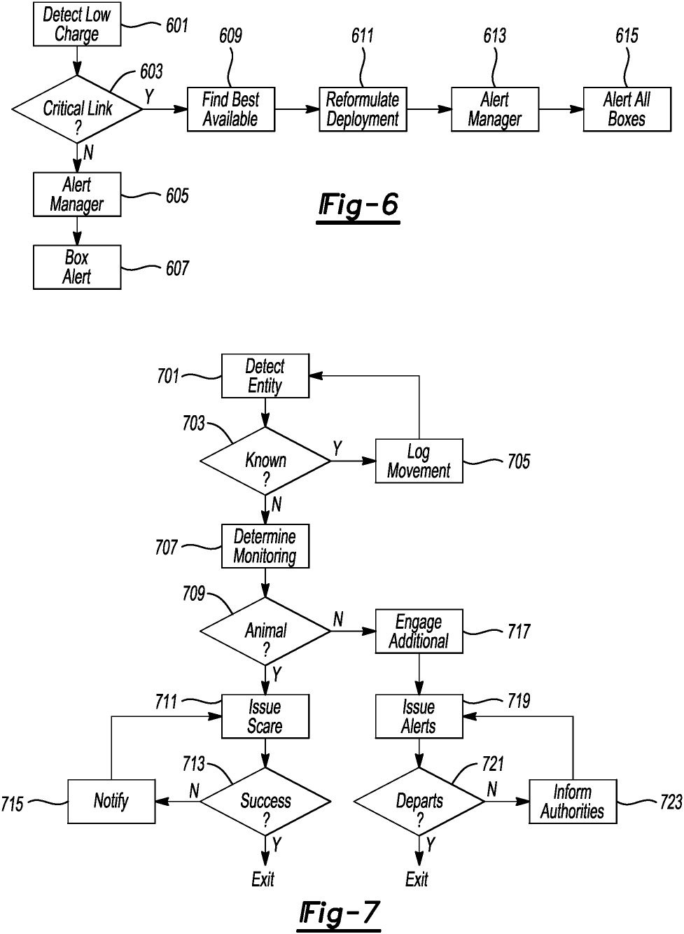

FIG. 6 shows an illustrative process for network modification responsive to detected issues. In this example, the vehicle 100 detects a low state of charge at a box 601. Boxes will need to be eventually recharged, which may be achievable for some boxes using solar or onsite power connections, but other boxes may be out of range of such sources of power and may need to be periodically refitted to the vehicle 100 or other charging. Again, if hot-swappable batteries are available, then the batteries can be used as portable power, serving both as temporary power sources and/or portable recharging sources, wherein power from a hot-swap battery is conveyed to a local supply in the box, and then the battery can be recharged and used again to recharge another box.

When redundancies are present in the network, the power exhaustion of one box should not have an immediate effect, but when the network relies on certain boxes, such as 503 and 505 in FIG. 5B to maintain the connection to the vehicle, or when the network relies on boxes such as 503, 505, 507 and 509 to provide enhanced security, exhaustion of a box’s power supply can present problems.

If the box is designated as critical at 603 (e.g., without limitation, if it performs a security function and/or forms a necessary connection point), then the process may alert a site manager at 605 or other responsible entity, so that there are assurances that responsible parties know of the potential power exhaustion and can address it. The vehicle 100 may also instruct the box to issue an alert at 607, and the box itself may be configured to automatically issue such an alert. If desired, the alert from a “critical” box can vary from a conventional low power alert for non-critical boxes, so that critical features of the onsite network are preserved.

As a possible alternative, in this example, the process finds an alternative box or usable power supply at 609. When boxes include tools necessary at a given location, swapping box locations may not be practical, but some boxes may be swappable and the vehicle 100 can determine which boxes are swappable based on tool usage and box contents compared to site plans. If an available box exists with more power and comparable capability at 609, the vehicle may reformulate a deployment at 611.

Boxes serving as the pipe for data or engaging sensors may experience more significant power loss, so swapping a perimeter box (e.g., 515 in FIG. 5A) for a security box (e.g. 505 in 5A) may allow both to complete a daily cycle by changing the power demands on each to meet available remaining power. This can also be accomplished by moving one or more hot-swappable batteries, such as backup batteries, from one box to another, if the boxes cannot be moved and the hot-swap is an available option.

In this instance, the manager may also be alerted at 613 once the configuration change is determined at 611. All boxes may be alerted to the change at 615, so that interruptions in the network are not read as permanent interruptions, if one or more boxes need to be moved. A worker can then swap the locations of two boxes if desired, under guidance from the vehicle 100 when needed.

FIG. 7 shows an illustrative monitoring and reaction process. This is an example of security provided by boxes using sensing capability of boxes. In this example, box sensors detect an entity present at a secure location, such as an entity breaking a perimeter or persistently detected by sensors of one or more boxes at 701.

In some instances, based on visual identification or RF identification, for example, the entity may be identifiable at 703. Workers may carry badges, for example, that allow for identification. Video may be analyzed when capability exists, to visually identify approved personnel. If the entity is known at 703, the process may simply log the presence of the person at 705 and continue monitoring.

If the entity is unknown at 703, the vehicle 100 or process-performing entity may determine a monitoring strategy for tracking the entity at 707. Since all boxes may not always have sensors engaged, boxes in proximity to the detecting box may be instructed to engage sensors at 717 if additional tracking is needed. This allows for tracking the entity over greater distances.

In this example, prior to engaging additional sensors, the process attempts to determine if the entity is an animal at 709. While animals are unlikely to steal equipment, they may present an undesired nuisance at a site, and the boxes can work to encourage the animal to move along. If the entity, based on sensing and recognition, appears to be an animal at 709, the box or boxes near the animal can issue scare noises designed to drive the animal away. If there is a given vector where it is desired to drive the animal, all boxes not in that vector can issue comparable noises, to attempt to funnel the animal in a desired direction.

If the attempts succeed at 713, the process exits and resumes detection. If the animal remains present, the process may notify a site manager or party responsible for animal control at 715 and continue attempting to remove the animal through scare issuance.

If the entity is not an animal, and thus in most instances a person (or person in a vehicle, for example), the process may engage additional sensors at 717, which can include increased sensing from monitoring boxes and enabling sensing on boxes not pre-designated for monitoring. This can increase the tracking range and field when necessary and help ensure the security of a site.

Additionally, alerts designed for scaring humans away may be issued at 719, which can include notification that the person was noticed and is being tracked, authorities have been contacted, etc. If the entity departs at 721, the process may log the incident and resume monitoring at 701, which may include shutting down the increased sensing or doing so after a predefined timeout has passed (in case the entity returns). If the entity lingers, the process may alert the proper authorities at 723.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
one or more processors configured to:
receive designation of a coverage area for deployment of a portable network comprised of a plurality of wireless-equipped toolboxes;
determine a plurality of toolboxes available for use in the network based on indications to the vehicle from a plurality of toolboxes that they are usable in the network;
determine a placement of the available toolboxes within the coverage area to achieve a wireless network having at least one box location capable of reaching a location designated as a vehicle parking location with wireless communication, the location determined by the one or more processors based at least in part on the ability of the vehicle to reach the location and a known cellular signal available at the location; and
provide guidance for deployment of individual toolboxes of the plurality of toolboxes at deployment locations according to the determined placement.

2. The vehicle of claim 1, wherein the designated includes designation of at least one secure area within the coverage area, for deployment of toolboxes having monitoring capability.

3. The vehicle of claim 1, wherein the indications are based at least in part on the toolboxes being physically connected to the vehicle through detectable connections.

4. The vehicle of claim 1, wherein the indications are based at least in part on the toolboxes being wirelessly connected to the vehicle.

5. The vehicle of claim 1, wherein the one or more processors are further configured to determine the deployment to include at least two box locations capable of reaching the location with wireless communication.

6. The vehicle of claim 1, wherein the one or more processors are further configured to select toolboxes, from the plurality of toolboxes, for deployment at specific locations deployment locations indicated by the placement, based on contents of the toolboxes, indicated by signals received from the toolboxes, correlated to activity planned within a predefined proximity to the locations, the activity designated as requiring one or more certain tools indicated by the contents.

7. The vehicle of claim 1, wherein the one or more processors are further configured to select toolboxes, from the plurality of toolboxes, for deployment at specific deployment locations indicated by the placement, based on power available to the toolboxes, indicated by signals received from the toolboxes, correlated to expected power draw of the toolboxes once placed and performing functions dictated by the placement.

8. The vehicle of claim 7, wherein the functions include at least one of wireless communication or sensor monitoring.

9. The vehicle of claim 1, wherein the guidance includes issuance of instructions through an audio or visual output of a selected toolbox from the plurality of toolboxes.

10. The vehicle of claim 9, wherein the instructions include at least one of audible signals, visual signals or verbal instructions.

11. The vehicle of claim 10, wherein the audible or visual signals increase in frequency relative to the proximity of the selected toolbox, indicated by a location signal received and correlated to the selected toolbox, to a corresponding specific deployment location designated by the placement for the selected toolbox.

11. The vehicle of claim 1, wherein the guidance includes issuance of instructions through a mobile device designated for outputting guidance.

12. A method comprising:
receiving a placement for a plurality of toolboxes, the placement indicating specific deployment locations for deployment of correlated ones of the plurality of toolboxes;
determining that a selected toolbox has been removed from a vehicle for deployment;
determining a location of the selected toolbox, relative to the specific deployment location correlated to the selective toolbox;
issuing audible or visual guidance for movement from the location of the selected toolbox to the specific deployment location; and
issuing deployment confirmation guidance when the location of the selected toolbox reaches the specific deployment location.

13. The method of claim 12, wherein the determining is based at least in part upon a disconnection of the selected toolbox from a detectable physical connection to the vehicle.

14. The method of claim 12, wherein the location of the selected toolbox is determined based on at least one of location signals received from a location sensor of the selected toolbox or a location sensor of a designated mobile device.

15. The method of claim 12, wherein the guidance includes audible guidance in the form of verbal instructions for movement of the toolbox.

16. The method of claim 12, wherein the guidance includes audible guidance in the form of signals varying in frequency relative to proximity of the location of the selected toolbox relative to the specific deployment location.

17. The method of claim 12, wherein the guidance includes visual guidance in the form of a flashing light pattern varying in frequency relative to proximity of the location of the selected toolbox relative to the specific deployment location.

18. The method of claim 12, wherein the guidance includes issuing guidance for an orientation of the selected toolbox, determined based on coverage of one or more sensors provided to the selected toolbox corresponding to an area of intended sensor coverage indicated by the placement.

19. The method of claim 12, further comprising issuing the guidance to at least one of the toolbox for output from an output of the toolbox or a designated wireless device for output from an output of the wireless device.

20. A method comprising:
receiving designation of a coverage area for deployment of a portable network comprised of a plurality of wireless-equipped toolboxes;
determining a plurality of toolboxes available for use in the network based on indications to the vehicle from a plurality of toolboxes that they are usable in the network;
determining a placement of the available toolboxes within the coverage area to achieve a wireless network having at least one box location capable of reaching a location designated as a vehicle parking location with wireless communication, the location determined by the one or more processors based at least in part on the ability of a vehicle to reach the location and a known cellular signal available at the location;
determining that a selected toolbox has been removed from a vehicle for deployment;
determining a location of the selected toolbox, relative to the specific deployment location correlated to the selective toolbox;
issuing audible or visual guidance for movement from the location of the selected toolbox to the specific deployment location; and
issuing deployment confirmation guidance when the location of the selected toolbox reaches the specific deployment location.
